(19) United States
(12) Patent Application Publication
(10) Pub. No.: US 2016/0088363 A1
(43) Pub. Date: Mar. 24, 2016

(54) MUSIC EDITING METHOD USING VIDEO STREAMING SERVICE AND MUSIC EDITING APPARATUS USED THEREFOR

(71) Applicant: Cheol SEOK, Daegu (KR)

(72) Inventors: Cheol SEOK, Daegu (KR); Ho-Kwang CHOI, Gyeonggi-do (KR)

(21) Appl. No.: 14/888,809

(22) PCT Filed: May 3, 2013
(86) PCT No.: PCT/KR2013/003835

§ 371 Date: Nov. 3, 2015

(51) Int. Cl. H04N 21/81; H04N 21/422; H04N 21/858; H04N 21/414

(52) U.S. Cl. CPC H04N 21/8113; H04N 21/41407; H04N 21/42203; H04N 21/8586

(57) ABSTRACT

Disclosed are a music editing method using a video streaming service and a music editing apparatus used therefor. The music editing apparatus receives URL information from a server in which each URL information of a plurality of video contents provided as a streaming service online is stored, streaming-reproduces a video corresponding to the URL information using the URL information, receives an audio signal input from a user through an audio input terminal, and mixes an audio output signal depending on the streaming-reproducing of the video and the audio signal input from the user, thereby realizing the present invention. According to the present invention, users may produce desired synthesized audio contents or synthesized video contents using UCC provided through a free video streaming service.

### TECHNICAL FIELD

The present invention relates to a music editing method using a video streaming service and a music editing apparatus used therefor, and more specifically, to a music editing method using a video streaming service which allows users to produce desired synthesized audio contents or synthesized video contents using user created contents (UCC) provided through a video streaming service, and a music editing apparatus used therefor.

### BACKGROUND ART

As an online streaming service referred to as “YouTube”, which provides video user created contents (UCCs) without charge, is widely distributed, users may easily access a number of music-related video UCC using personal terminals such as smartphones.

Meanwhile, since the music-related video UCC provided without charge also includes audio contents of the corresponding music in addition to the video contents, there is no need for the user to purchase paid contents such as MP3 in order to listen desired music.

Some users want to synthesize or edit audio parts of the video UCC containing desired music with user's voice or other external input audio signal, however, techniques for satisfying their needs have not yet been developed.

### DISCLOSURE

### Technical Problem

Accordingly, it is an object of the present invention is to provide a music editing method using a video streaming service which allows users to produce desired synthesized audio contents or synthesized video contents using user created contents (UCC) provided through a video streaming service, and a music editing apparatus used therefor.

### Technical Solution

According to one aspect of the present invention, there is provided a music editing method using a video streaming service, including: (a) receiving, by a music editing apparatus, URL information from a server in which each URL information of a plurality of video contents provided as a streaming service online is stored; (b) streaming-reproducing, by the music editing apparatus, a video corresponding to the URL information using the URL information; (c) receiving, by the music editing apparatus, an audio signal input from a user through an audio input terminal; and (d) mixing, by the music editing apparatus, an audio output signal depending on the streaming-reproducing of the video and the audio signal input from the user.

Preferably, the music editing method using a video streaming service further includes: combining, by the music editing apparatus, a synthesized audio signal mixed in step (d) with an external input video.

In addition, the music editing method using a video streaming service may further include: stopping, by the music editing apparatus, the streaming-reproducing of the video in step (b) and the mixing in step (d) according to an input of a control instruction from the user.

In addition, the music editing method using a video streaming service may further include: after step (a) and before step (b), storing, by the music editing apparatus, the URL information received from the server.

In addition, the music editing method using a video streaming service may further include: editing, by the music editing apparatus, the stored URL information.

Meanwhile, according to another aspect of the present invention, there is provided a music editing apparatus, including: a receiving unit configured to receive URL information from a server in which each URL information of a plurality of video contents provided as a streaming service online is stored; a reproducing unit configured to streaming-reproduce a video corresponding to the URL information using the URL information; and a mixing unit configured to mix an audio output signal resulting from the streaming-reproduction of the video and an audio signal input from a user through an audio input terminal.

Preferably, the music editing apparatus may further include: an editing unit configured to combine a synthesized audio signal mixed in the mixing unit with an external input video.

In addition, the music editing apparatus may further include: a control unit configured to stop the streaming-reproduction of the video in the reproducing unit, and the mixing in the mixing unit, according to a control instruction input from the user.

In addition, the music editing apparatus may further include: a storage unit configured to store the URL information received from the server by the receiving unit.

In addition, the music editing apparatus may further include: an editing unit configured to edit the URL information stored in the storage unit.

### Advantageous Effects

According to the present invention, users may produce desired synthesized audio contents or synthesized video contents using the UCC provided through the free video streaming service.

### DESCRIPTION OF DRAWINGS

FIG. 1 is a view illustrating a structure of a music editing system using a video streaming service according to an embodiment of the present invention.

FIG. 2 is a functional block diagram describing a structure of a music editing apparatus used for the music editing system using a video streaming service according to the embodiment of the present invention.

FIG. 3 is a flow chart describing a process of a music editing method using a video streaming service according to the embodiment of the present invention.

### BEST MODE

Hereinafter, the present invention will be described in more detail with reference to accompanying drawings. In the drawings, same reference numerals denote same components throughout the disclosure. Known functions and configurations which may unnecessarily obscure the gist of the present invention will not be described.

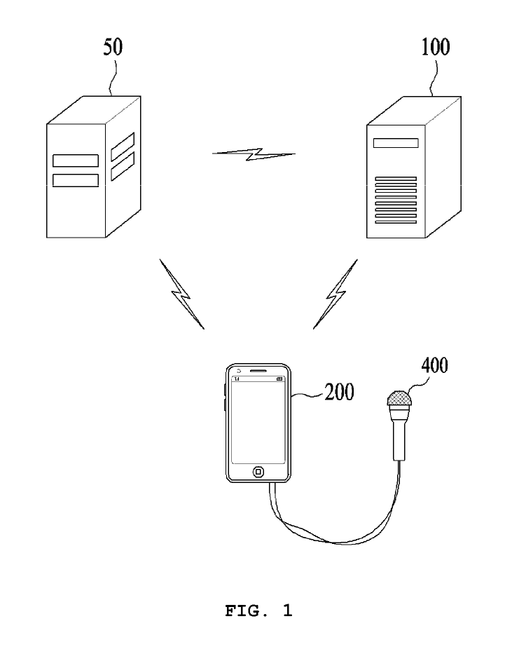

FIG. 1 is a view illustrating a structure of a music editing system using a video streaming service according to an embodiment of the present invention. Referring to FIG. 1, the music editing system using a video streaming service according to the embodiment of the present invention includes a video providing server 50, a list providing server 100, and a music editing apparatus 200.

The video providing server 50 which is a server operated by operators providing the video streaming service online, such as YouTube, stores a number of music video contents. Each of the music video contents is managed with independent URL applied thereto.

Specifically, the music video contents provided as a streaming service from the video providing server 50 have independent URL in which unique URL of corresponding server and a video ID of each of the music video contents consisting of a total of 11 digits are combined.

Meanwhile, the list providing server 100 is a server which collects, extracts, and stores the URLs of the music video contents managed by the video providing server 50, which serves to assist users to easily access the music video contents.

Further, the music editing apparatus 200 servers to streaming-reproduce the video contents based on the URL of the music video contents provided from the list providing server 100, and mix an audio output signal of the reproduced video contents and an external input audio signal, to thereby produce a synthesized audio signal.

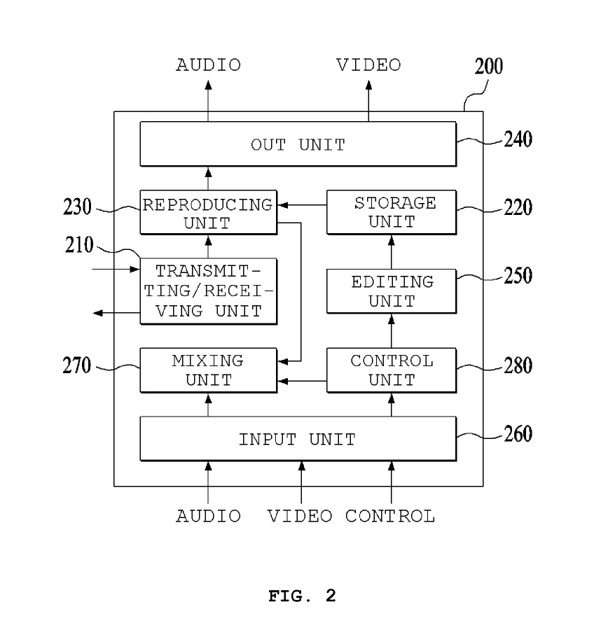

FIG. 2 is a functional block diagram describing a structure of a music editing apparatus 200 used for the music editing system using a video streaming service according to the embodiment of the present invention. Referring to FIG. 2, the music editing apparatus 200 used for the music editing system using a video streaming service according to the embodiment of the present invention includes a transmitting/receiving unit 210, a storage unit 220, a reproducing unit 230, an output unit 240, an editing unit 250, an input unit 260, a mixing unit 270, and a control unit 280.

First, the transmitting/receiving unit 210 serves to receive an URL information of the video contents from the list providing server 100 through wired or wireless communications. The storage unit 220 serves to store the corresponding URL information.

The reproducing unit 230 serves to streaming-reproduce a video corresponding to the URL information using the URL information received from the list providing server 100, and the output unit 240 supports the video output and audio output of the video reproduced by the reproducing unit 230.

Meanwhile, the editing unit 250 serves to edit the URL information stored in the storage unit 220 for various categories such as latest songs, popular songs, music genre, etc., according to the user's request. The input unit 260 includes an input panel receiving a control instruction for the music editing apparatus 200 from the user, an audio input terminal such as a microphone terminal through which an external audio signal is input, etc., and a video input terminal through which an external video signal is input.

Also, the mixing unit 270 serves to mix the audio output signal depending on the streaming-reproduction of the video in the reproducing unit 230 and the audio signal input from the user through the audio input terminal.

Meanwhile, the control unit 280 serves to stop or restart the streaming-reproduction of the video in the reproducing unit 230, and the mixing in the mixing unit 270 according to the control instruction of the user input through the input panel.

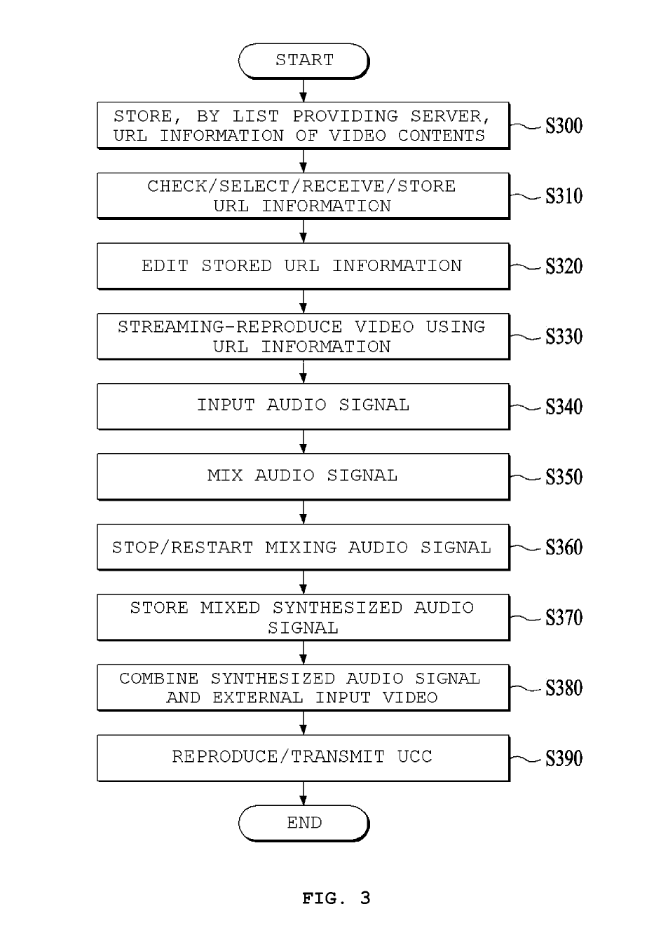

FIG. 3 is a flow chart describing a process of a music editing method using a video streaming service according to an embodiment of the present invention. Referring to FIGS. 1 to 3, the process of the music editing method using the video streaming service according to an embodiment of the present invention will be described. First, the list providing server 100 includes a database which stores a list of individual URL information of the video contents provided in a streaming manner from the video providing server 50 (S300).

Meanwhile, the list providing server 100 may also regularly receive and store the list of corresponding URL information from the video providing server 50, and may also store the list of the URL information which is collected and input by an operator of the list providing server 100 himself/herself.

Next, the user accesses the list providing server 100 through the music editing apparatus 200 having wired/wireless communication function, checks the URL information of the desired music video contents, and selects the checked URL information, and thereby receiving URL information of the music video contents from the list providing server 100 (S310).

The URL information received as described above are stored in the storage unit 220 of the music editing apparatus 200, and the user inputs an edit instruction through the input unit 260 to edit and store the URL information stored in the storage unit 220 for various categories such as latest songs, popular songs, music genre, etc. (S320)

Then, the user selects URL information corresponding to desired music video contents among the URL information edited and stored for each category in the storage unit 220, through the input panel, and the music editing apparatus 200 accesses the corresponding URL, and the music video contents are streaming-reproduced in the music editing apparatus 200 through a published application program interface (API) provided from the video providing server 50 (S330).

Meanwhile, in carrying out the present invention, the streaming-reproduction of the music video contents may be performed via a web browser, and may also be performed via the reproducing unit 230 having a streaming-reproduction program installed therein which is distributed through the video providing server 50.

Further, in carrying out the present invention, the music editing apparatus 200 may be a smartphone having a predetermined streaming-reproduction program installed therein. In this case, a predetermined application program performing functions of the editing unit 250, the mixing unit 270, and the control unit 280 in FIG. 2 needs to be downloaded from the application store and installed in the smartphone.

As the music video contents are streaming-reproduced, an audio part and a video part of the corresponding contents are provided to the user through the output unit 240 corresponding to a monitor and a speaker of the music editing apparatus 200.

As such, when the music video contents selected by the user are reproduced, the user connects a microphone 400 to the audio input terminal of the music editing apparatus 200, and inputs a voice such as a song sung by the user through the input unit 260 (S340).

Then, the mixing unit 270 of the music editing apparatus 200 obtains the audio output signal from the output unit 240 depending on the streaming-reproduction of the video by capturing the audio output signal in a digital RAW audio format, obtains the audio signal input from the user through the input unit 260 by capturing the audio signal in the same digital RAW audio format, and mixes the two audio signals, and thereby producing a synthesized audio signal and synthesized audio contents (S350).

Meanwhile, when temporarily stopping the mixing operation, the user clicks a “STOP” button provided in the input panel of the music editing apparatus 200 to stop the input of voice through the microphone 400. Thereby, the control unit 280 simultaneously stops the streaming-reproduction of the video by the reproducing unit 230, and the mixing by the mixing unit 270.

Then, the user clicks a “START” button provided in the input panel of the music editing apparatus 200 to restart the input of voice through the microphone 400. Thereby, the control unit 280 simultaneously restarts the streaming-reproduction of the video by the reproducing unit 230, and the mixing by the mixing unit 270 (S360).

The synthesized audio signal and the synthesized audio contents (audio user created contents (UCCs)) produced by the mixing unit 270 as described above are stored in the storage unit 220 (S370).

Meanwhile, when the video signal is input through the video signal terminal of the input unit 260, the editing unit 250 combines the synthesized audio signal which is stored in the above-described step S370 with the video signal input through the input unit 260 according to the selection of the user through the input panel, such that synthesized video contents (video UCC) in which the video part and the synthesized audio part are combined are produced (S380).

In this regard, during producing the synthesized video contents (video UCC) in the above-described step S380, the synthesized audio signal stored in the storage unit 220 and the video contents pre-stored in the storage unit 220 may be combined with each other.

The video UCC produced as described above is stored in the storage unit 220 of the music editing apparatus 200. When the user selects the corresponding video UCC through the input panel and clicks a ‘REPRODUCE’ button provided therein, the reproducing unit 230 reproduces the selected video UCC, and the reproduced video UCC is provided to the user through the output unit 240 (S390).

Further, when the user selects the audio UCC stored in the storage unit 220 in the above-described step S370 through the input panel and clicks the ‘REPRODUCE’ button, the reproducing unit 230 reproduces the selected audio UCC, and the reproduced audio UCC is provided to the user through the output unit 240 (S390).

Also, the user may transmit the synthesized audio contents (audio UCC) or the synthesized video contents (video UCC) stored in the storage unit 220 to external devices through the transmitting/receiving unit 210 as necessary (S390).

Although preferred embodiments and applications of the present invention have been described above, the present invention should not be construed as being limited to the above described specific embodiments and applications, but may be variously modified and embodied by a person having ordinary skill in the art to which the present invention pertains without departing from the gist of the present invention claimed in the appended claims. Such modifications should not be considered as departing from the technical idea or scope of the present invention.

In addition, terms used herein are for the purpose of describing specific embodiments only, but are not intended to limit the present invention. A singular form includes a plural form unless the context clearly indicates otherwise. Throughout this specification, it will be understood that the term “comprise” and variations thereof, such as “comprising” and “having,” specify the presence of features, numbers, steps, operations, components, parts, or combinations thereof, described in the specification, but do not preclude the presence or addition of one or more other features, numbers, steps, operations, components, parts, or combinations thereof.

### INDUSTRIAL APPLICABILITY

The present invention is applicable in the online contents-related industrial field.

1. A music editing method using a video streaming service, comprising:
(a) receiving, by a music editing apparatus, URL information from a server in which each URL information of a plurality of video contents provided as a streaming service online is stored;
(b) streaming-reproducing, by the music editing apparatus, a video corresponding to the URL information using the URL information;
(c) receiving, by the music editing apparatus, an audio signal input from a user through an audio input terminal; and
(d) mixing, by the music editing apparatus, an audio output signal depending on the streaming-reproducing of the video and the audio signal input from the user.

2. The music editing method using a video streaming service of claim 1, further comprising: combining, by the music editing apparatus, a synthesized audio signal mixed in step (d) with an external input video.

3. The music editing method using a video streaming service of claim 1, further comprising: stopping, by the music editing apparatus, the streaming-reproducing of the video in step (b) and the mixing in step (d) according to an input of a control instruction from the user.

4. The music editing method using a video streaming service of claim 1, further comprising: after step (a) and before step (b), storing, by the music editing apparatus, the URL information received from the server.

5. The music editing method using a video streaming service of claim 4, further comprising: editing, by the music editing apparatus, the stored URL information.

6. A music editing apparatus, comprising:
a receiving unit configured to receive URL information from a server in which each URL information of a plurality of video contents provided as a streaming service online is stored;
a reproducing unit configured to streaming-reproduce a video corresponding to the URL information using the URL information; and
a mixing unit configured to mix an audio output signal depending on the streaming-reproducing of the video and an audio signal input from a user through an audio input terminal.

7. The music editing apparatus of claim 6, further comprising: an editing unit configured to combine a synthesized audio signal mixed in the mixing unit with an external input video.

8. The music editing apparatus of claim 7, further comprising: a control unit configured to stop the streaming-reproducing of the video in the reproducing unit, and the mixing in the mixing unit, according to a control instruction input from the user.

9. The music editing apparatus of claim 6, further comprising: a storage unit configured to store the URL information received from the server by the receiving unit.

10. The music editing apparatus of claim 9, further comprising: an editing unit configured to edit the URL information stored in the storage unit.
